(19) United States
(12) Patent Application Publication
(10) Pub. No.: US 2024/0323765 A1
(43) Pub. Date: Sep. 26, 2024

(54) BALANCED MODEL DISTRIBUTION IN NETWORK

(71) Applicant: Parsa Wireless Communications LLC, Stamford, CT (US)

(72) Inventor: Andreas Falkenberg, Escondido, CA (US)

(73) Assignee: Parsa Wireless Communications LLC, Stamford, CT (US)

(21) Appl. No.: 18/610,042

(22) Filed: Mar. 19, 2024

Related U.S. Application Data
(60) Provisional application No. 63/453,411, filed on Mar. 20, 2023.

(51) Int. Cl. H04W 28/08; H04W 24/08

(52) U.S. Cl. CPC H04W 28/0958; H04W 24/08

(57) ABSTRACT

A load balancing method implemented by a wireless server in a wireless network includes deriving an intelligent model to determine network parameters, determining a model-download cost of transferring the intelligent model from the network server to a user equipment (UE), determining a data-upload cost of transferring data to be processed by the intelligent model from the UE to the server, determining a data-download cost of transferring output data processed by the intelligent model from the server to the UE, determining to transfer the intelligent model from the server to the UE, or transfer the data from the UE to the server and processing the data by the intelligent model.

### CROSS-REFERENCE TO RELATED APPLICATION

This application claims priority under 35 USC § 119(e) from U.S. Provisional Patent Application No. 63/453,411, filed on Mar. 20, 2023 (“the provisional application”); the content of the provisional patent application is incorporated herein by reference.

### BACKGROUND OF THE INVENTION

The present invention is directed to 5G, which is the 5th generation mobile network. It is a new global wireless standard after 1G, 2G, 3G, and 4G networks. 5G enables networks designed to connect machines, objects and devices.

The invention includes enhancing conventional load balancing by a wireless server that includes deriving an intelligent model to determine network parameters and model-download and model-upload transfer costs to and from a user equipment, respectively and making a decision whether to transfer based thereon.

### SUMMARY OF THE INVENTION

In an embodiment, the invention provides a load balancing method implemented by a wireless server in a wireless network includes deriving an intelligent model to determine network parameters, determining a model-download cost of transferring the intelligent model from the network server to a user equipment (UE), determining a data-upload cost of transferring data to be processed by the intelligent model from the UE to the server, determining a data-download cost of transferring output data processed by the intelligent model from the server to the UE, determining to transfer the intelligent model from the server to the UE, or transfer the data from the UE to the server and processing the data by the intelligent model. The intelligent model may include an artificial intelligent model, which determines network parameters dynamically according to network traffic.

The load balancing method can include calculating a total cost of data transfer by adding the data-upload cost of transferring the data from the (user equipment) UE to the server, and the data-download cost of transferring the output data from the server to the UE, comparing the total cost with the model-download cost of transferring the model from the server to the UE and transferring or not transferring the intelligent model to the UE based on the comparison result. The server can transfer the intelligent model to the UE where the total cost is larger than the model-download cost of transferring the intelligent model to the user equipment (UE). The load balancing method might also include determining a number of times the intelligent model is used to process user equipment (UE) data, calculating a sum of the data-upload cost of transferring the data from the UE to the server, and the data-download cost of transferring the output data from the server to the UE, multiplying the sum by the number of times of the intelligent model is used to calculate a total cost of data transfer, comparing the total cost of data transfer with the model-download cost of transferring the intelligent model from the server to the UE and transferring or not transferring the intelligent model to the UE based on the comparison result.

In the load balancing method, the server can transfer the intelligent model to the user equipment UE where the total cost is larger than the cost of transferring the intelligent model to the UE. The number of times the intelligent model is used can be determined by a moving average process. For that matter, the load balancing method also can include determining the number of times the intelligent model is used to process user equipment (UE) data, calculating a first metric that is equivalent to a ratio of the upload-data cost of transferring the data from the UE to the server to available upload bandwidth, calculating a second metric that is equivalent to a ratio of the download-data cost of transferring the output data from the server to available download bandwidth, summing the first metric with the second metric, multiplying the summation result by the number of times the intelligent model is used to calculate a total cost of data transfer, comparing the total cost of data transfer with the download-model cost of transferring the model from the server to the UE and transferring or not transferring the intelligent model to the UE based on the comparison result. The number of times the intelligent model is used may be determined by a moving average process. The download bandwidth may be determined based on the downlink traffic. The upload bandwidth may be determined based on the uplink traffic.

In an embodiment, the invention may comprise a server with a processor and a transceiver, wherein the processor is programmed to: implement an intelligent model to determine network parameters, determine a model-download cost of transferring the intelligent model from the network server to a user equipment (UE), determine an upload-data cost of transferring data to be processed by the intelligent model from the UE to the server, determine a download-data cost of transferring output data processed by the intelligent model from the server to the UE, determine to transfer the intelligent model from the server to the UE, or transfer the data from the UE to the server and if the data are transferred to the server, process the data by the intelligent model and wherein the transceiver is configured to: receive the data uploaded from the UE and in a case where the data are uploaded to the server, transmit the output data processed by the intelligent model from the server to the UE. The intelligent model can include an artificial intelligent model which determines network parameters dynamically according to network traffic.

The processor may be further programmed to: calculate a total cost of data transfer by adding a data-upload cost of transferring the data from the user equipment (UE) to the server, and a data-download cost of transferring output data from the server to the UE, compare the total cost with the model-download cost of transferring the model from the server to the UE and transfer or not transfer the intelligent model to the UE based on the comparison result. The transceiver can be further configured to transfer the intelligent model to the user equipment (UE) where the total cost is larger than the upload-data cost of transferring the intelligent model to the UE.

The processor can be further programmed to: determine a number of times the intelligent model is used to process user equipment (UE) data, calculate a sum of the upload-data cost of transferring the data from the UE to the server, and the download-data cost of transferring the output data from the server to the UE, multiply the sum by the number of times of the intelligent model is used to calculate the total cost of data transfer, compare the total cost with the model-download cost of transferring the model from the server to the UE and transfer or not transfer the intelligent model to the UE based on the comparison result the processor is further programmed to transfer the intelligent model to the user equipment (UE) where the total cost is larger than the model-download cost of transferring the intelligent model to the UE.

For that matter, the processor may be further programmed to: determine a number of times the intelligent model is used to process user equipment (UE) data, calculate a sum of the data-upload cost of transferring the data from the UE to the server, and the data-download cost of transferring the output data from the server to the UE, multiply the sum by the number of times of the intelligent model is used to calculate the total cost of data transfer, compare the total cost with the model-download cost of transferring the model from the server to the UE and transfer or not transfer the intelligent model to the UE based on the comparison result. The processor may also be further programmed to transfer the intelligent model to the user equipment (UE) where the total cost is larger than the model-download cost of transferring the intelligent model to the UE.

In an embodiment, the invention provide a non-transitory computer-readable storage medium having stored therein instructions which, when executed by one or more processors, cause the one or more processors to: generate an intelligent model to determine network parameters; determine a model-download cost of transferring the intelligent model from a network server to a user equipment (UE), determine a data-upload cost of transferring data to be processed by the intelligent model from the UE to the network server, determine data-download cost of transferring output data processed by the intelligent model from the network server to the UE, determine to transfer the intelligent model from the server to the UE, or to transfer the data from the UE to the server, cause the data to be processed by the intelligent model. The intelligent model may process the data at the user equipment, uploading the UE-processed data to the network server. The network server may receive the data from the user equipment (UE), transmitting the output data processed by the intelligent model from the server to a UE.

### BRIEF DESCRIPTION OF THE DRAWINGS

FIG. 1 shows an example of a system of mobile communications according to some aspects of some of various exemplary embodiments of the present disclosure.

FIG. 2A and FIG. 2B show examples of radio protocol stacks for user plane and control plane, respectively, according to some aspects of some of various exemplary embodiments of the present disclosure.

FIG. 3A, FIG. 3B and FIG. 3C show example mappings between logical channels and transport channels in downlink, uplink and sidelink, respectively, according to some aspects of some of various exemplary embodiments of the present disclosure.

FIG. 4A, FIG. 4B and FIG. 4C show example mappings between transport channels and physical channels in downlink, uplink and sidelink, respectively, according to some aspects of some of various exemplary embodiments of the present disclosure.

FIG. 5A, FIG. 5B, FIG. 5C and FIG. 5D show examples of radio protocol stacks for NR sidelink communication according to some aspects of some of various exemplary embodiments of the present disclosure.

FIG. 6 shows example physical signals in downlink, uplink and sidelink according to some aspects of some of various exemplary embodiments of the present disclosure.

FIG. 7 shows examples of Radio Resource Control (RRC) states and transitioning between different RRC states according to some aspects of some of various exemplary embodiments of the present disclosure.

FIG. 8 shows example frame structure and physical resources according to some aspects of some of various exemplary embodiments of the present disclosure.

FIG. 9 shows example component carrier configurations in different carrier aggregation scenarios according to some aspects of some of various exemplary embodiments of the present disclosure.

FIG. 10 shows an example of system block diagram of intelligent balanced model distribution according to some aspects of some of various exemplary embodiments of the present disclosure.

FIG. 11 shows an example of balanced model distribution when the user data is transferred from a UE to a server according to some aspects of some of various exemplary embodiments of the present disclosure.

FIG. 12 shows an example of balanced model distribution when model is transferred from a server to a UE according to some aspects of some of various exemplary embodiments of the present disclosure.

FIG. 13 shows example components of a UE for transmission and/or reception according to some aspects of some of various exemplary embodiments of the present disclosure.

FIG. 14 shows example components of a server for transmission and/or reception according to some aspects of some of various exemplary embodiments of the present disclosure.

FIG. 15 shows a flow diagram illustrating a method of balanced load distribution performed by a UE according to some aspects of some of various exemplary embodiments of the present disclosure.

### DETAILED DESCRIPTION OF THE INVENTION

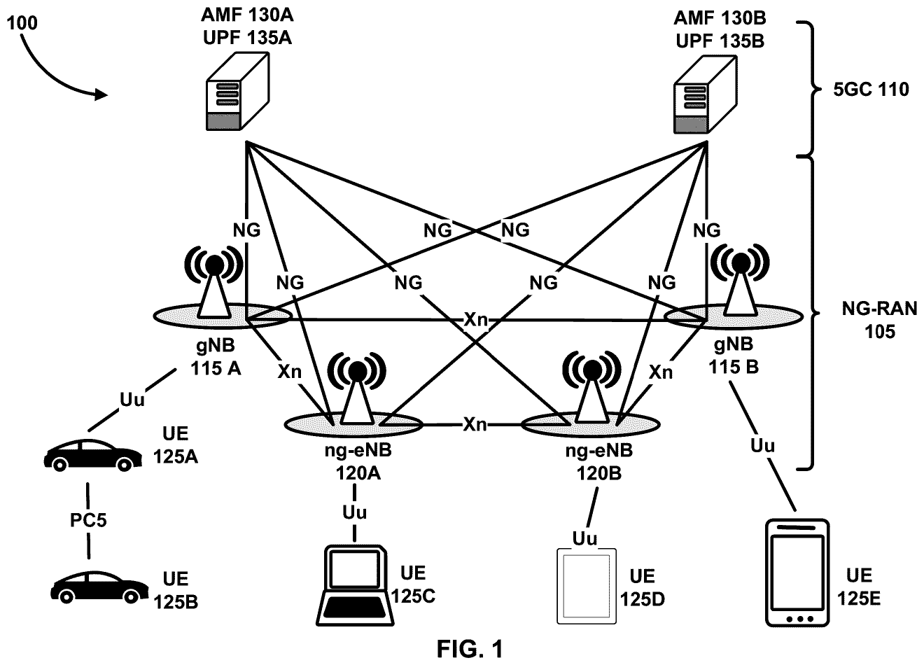

FIG. 1 shows an example of a system of mobile communications 100 according to some aspects of some of various exemplary embodiments of the present disclosure. The system of mobile communication 100 may be operated by a wireless communications system operator such as a Mobile Network Operator (MNO), a private network operator, a Multiple System Operator (MSO), an Internet of Things (IoT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IoT (IIOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support applications with strict requirements in terms of latency and reliability and moderate requirements in terms of data rate. Example mMTC application includes a network of a massive number of IoT devices, which are only sporadically active and send small data payloads.

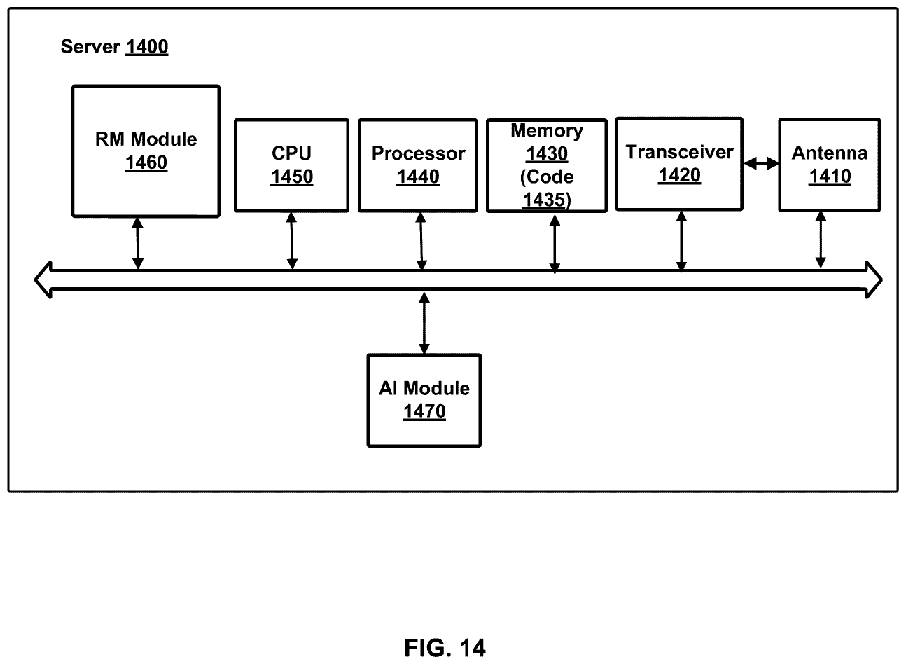

The system of mobile communications 100 may include a Radio Access Network (RAN) portion and a core network portion. The example shown in FIG. 1 illustrates a Next Generation RAN (NG-RAN) 105 and a 5G Core Network (5g-CN) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 and the core network FIG. 14 shows example of SL resource allocation process with pre-emption for aperiodic traffic according to some aspects of some of various exemplary embodiments of the present disclosure. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UE 125 and the RAN (e.g., the NG-RAN 105) may be referred to as Access Stratum (AS) and the functional layer between the UE 125 and the core network (e.g., the 5G-CN 110) may be referred to as Non-access Stratum (NAS).

The UEs 125 may include wireless transmission and reception means for communications with one or more nodes in the RAN, one or more relay nodes, or one or more other UEs, etc. Example of UEs include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for UEs such as a Mobile Station (MS), terminal equipment, terminal node, client device, mobile device, etc.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that used the UMTS RAT. A RAN node may be referred to as an evolved Node B (CNB) in a RAN that uses LTE/EUTRA RAT. For the illustrative example of the system of mobile communications 100 in FIG. 1, the nodes of an NG-RAN 105 may be either a next generation Node B (gNB) 115 or a next generation evolved Node B (ng-eNB) 120. In this specification, the terms base station, RAN node, gNB and ng-eNB may be used interchangeably. The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and GPRS Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 of the 5GC 110 by means of the NG-C interface and to a User Plane Function (UPF) 135 of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIoT optimizations.

The UPF 135 may host one or more of the following functions: Anchor point for Intra-/Inter-RAT mobility (when applicable); External PDU session point of interconnect to Data Network; Packet routing & forwarding; Packet inspection and User plane part of Policy rule enforcement; Traffic usage reporting; Uplink classifier to support routing traffic flows to a data network; Branching point to support multi-homed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE125B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may identify the sender of the data in NR sidelink communication. The Source Layer-2 ID may be 24 bits long and may be split in the MAC layer into two bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the Medium Access Control (MAC) header. This may be used for filtering packets at the MAC layer of the receiver. The Destination Layer-2 ID may identify the target of the data in NR sidelink communication. For NR sidelink communication, the Destination Layer-2 ID may be 24 bits long and may be split in the MAC layer into two bit strings: One bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

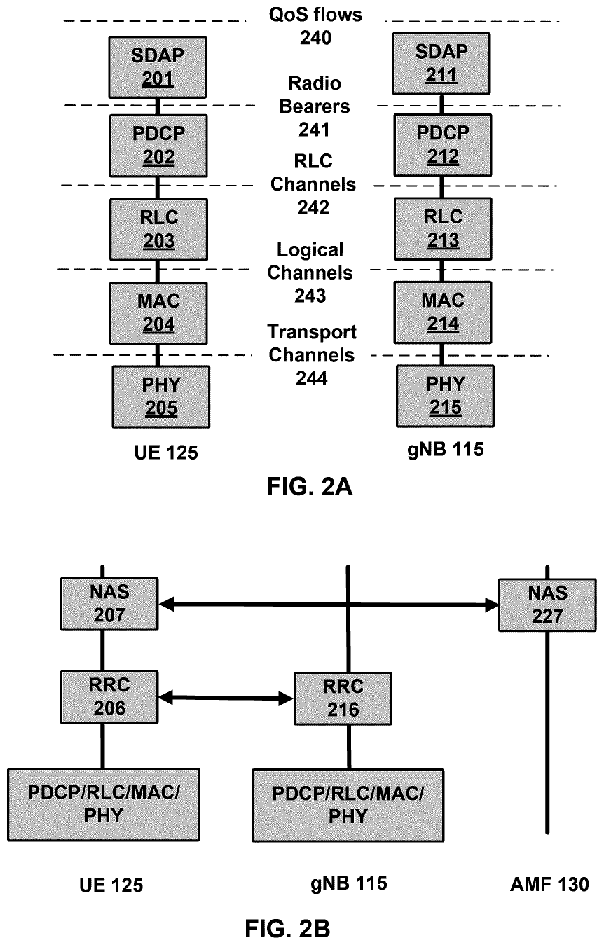

FIG. 2A and FIG. 2B show examples of radio protocol stacks for user plane and control plane, respectively, according to some aspects of some of various exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and re-segmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

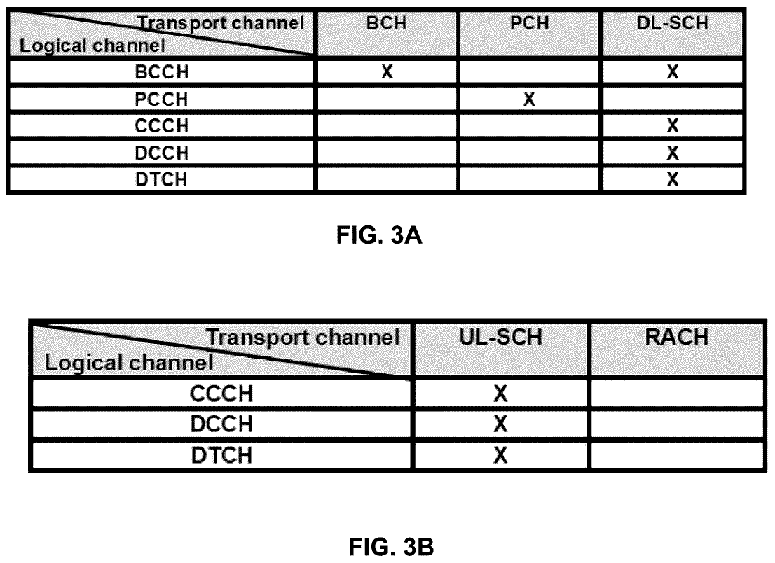

FIG. 3A, FIG. 3B and FIG. 3C show example mappings between logical channels and transport channels in downlink, uplink and sidelink, respectively, according to some aspects of some of various exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is channel for transmitting control information between UEs and networks. This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). The BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; support for UE discontinuous reception (DRX) to enable UE power saving. The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information; and collision risk.

In Uplink, the following connections between logical channels and transport channels may exist: CCCH may be mapped to UL-SCH; DCCH may be mapped to UL-SCH; and DTCH may be mapped to UL-SCH.

The sidelink transport channel types include: Sidelink broadcast channel (SL-BCH) and Sidelink shared channel (SL-SCH). The SL-BCH may be characterized by pre-defined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SL-SCH; and SBCCH may be mapped to SL-BCH.

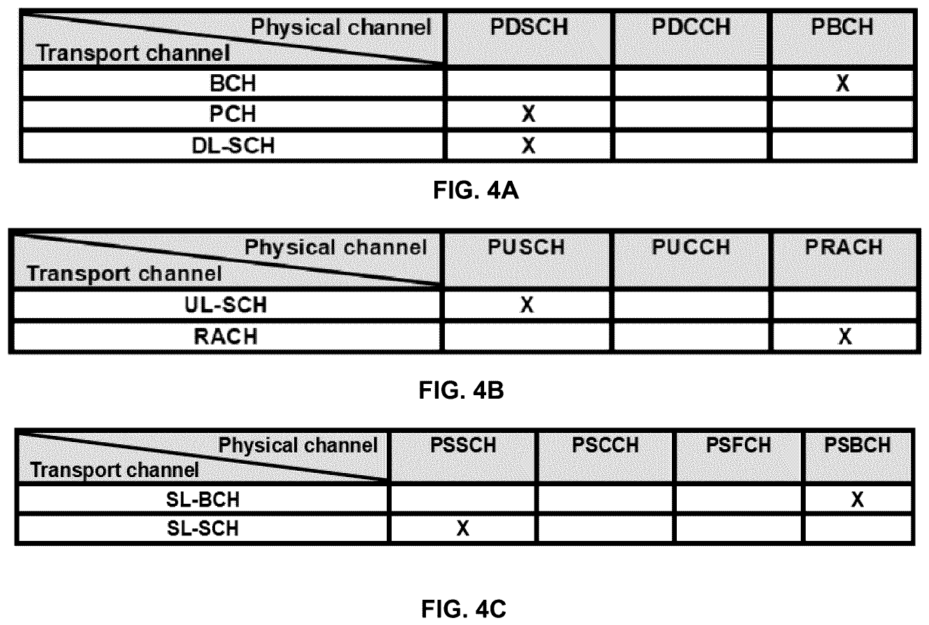

FIG. 4A, FIG. 4B and FIG. 4C show example mappings between transport channels and physical channels in downlink, uplink and sidelink, respectively, according to some aspects of some of various exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and CSI feedback triggers, etc. At least 6 OFDM symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may mapped to the PSCCH.

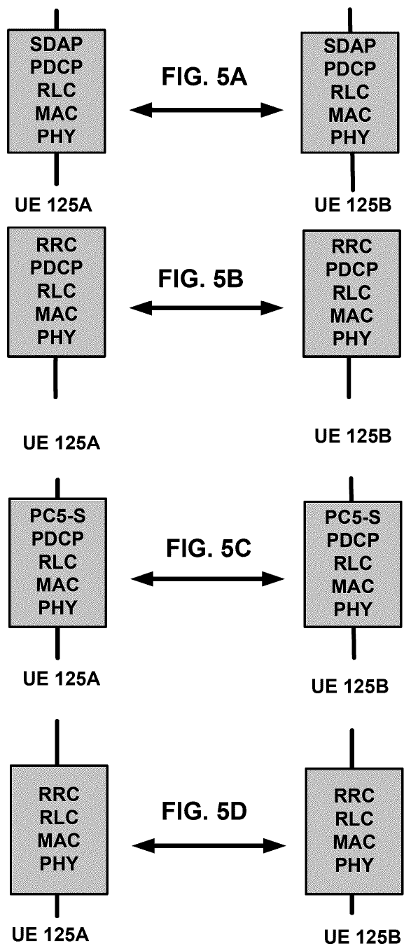

FIG. 5A, FIG. 5B, FIG. 5C and FIG. 5D show examples of radio protocol stacks for NR sidelink communication according to some aspects of some of various exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

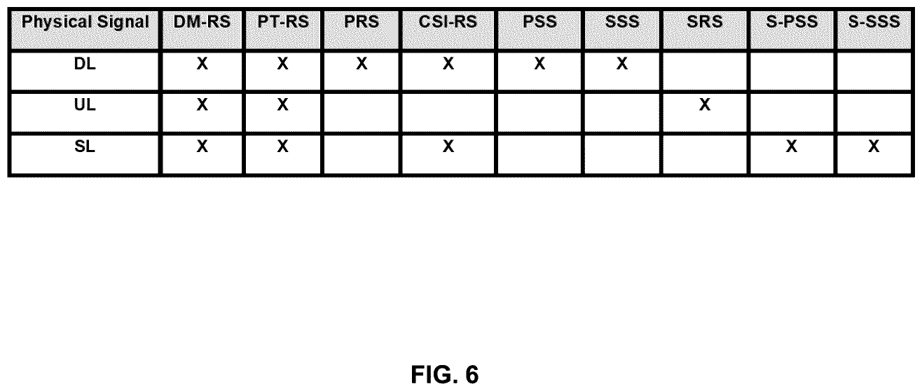

FIG. 6 shows example physical signals in downlink, uplink and sidelink according to some aspects of some of various exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses. CSI-RS may be configured UE-specifically but multiple users may share the same CSI-RS resource. The UE may determine CSI reports and transit them in the uplink to the base station using PUCCH or PUSCH. The CSI report may be carried in a sidelink MAC CE. The Primary Synchronization Signal (PSS) and the Secondary Synchronization Signal (SSS) may be used for radio fame synchronization. The PSS and SSS may be used for the cell search procedure during the initial attachment or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

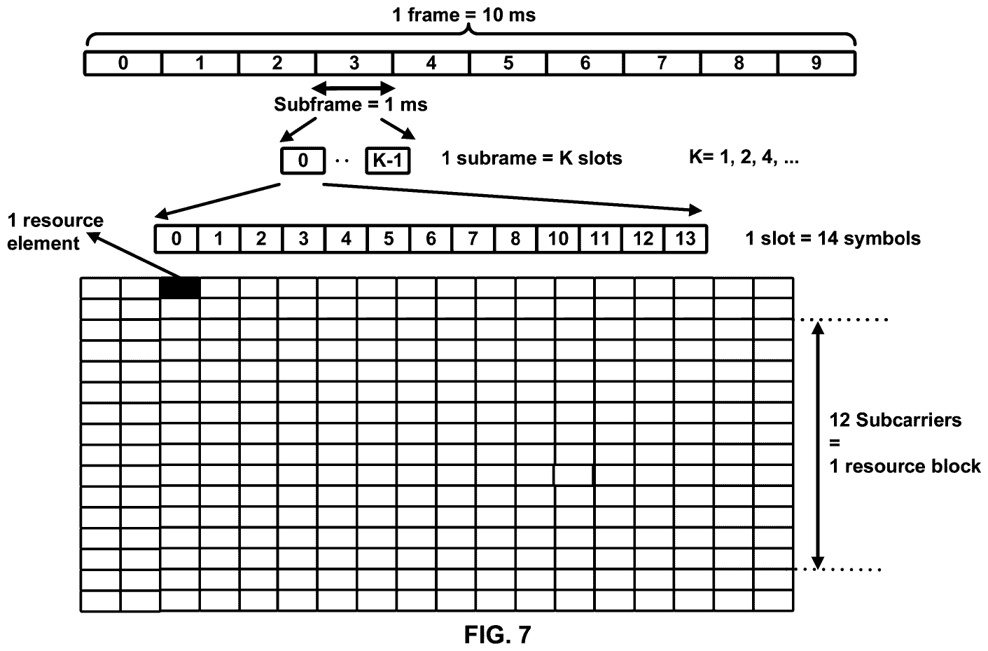

FIG. 7 shows example frame structure and physical resources according to some aspects of some of various exemplary embodiments of the present disclosure. The downlink or uplink or sidelink transmissions may be organized into frames with 10 ms duration, consisting of ten 1 ms subframes. Each subframe may consist of 1, 2, 4, . . . slots, wherein the number of slots per subframe may depend of the subcarrier spacing of the carrier on which the transmission takes place. The slot duration may be 14 symbols with Normal Cyclic Prefix (CP) and 12 symbols with Extended CP and may scale in time as a function of the used sub-carrier spacing so that there is an integer number of slots in a subframe. FIG. 7 shows a resource grid in time and frequency domain. Each element of the resource grid, comprising one symbol in time and one subcarrier in frequency, is referred to as a Resource Element (RE). A Resource Block (RB) may be defined as 12 consecutive subcarriers in the frequency domain.

In some examples and with non-slot-based scheduling, the transmission of a packet may occur over a portion of a slot, for example during 2, 4 or 7 OFDM symbols which may also be referred to as mini-slots. The mini-slots may be used for low latency applications such as URLLC and operation in unlicensed bands. In some embodiments, the mini-slots may also be used for fast flexible scheduling of services (e.g., pre-emption of URLLC over eMBB).

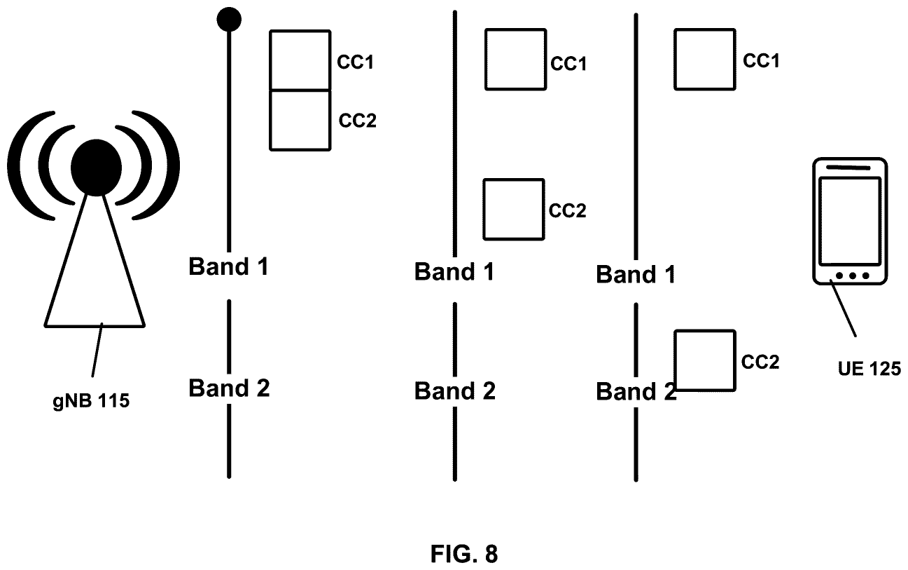

FIG. 8 shows example component carrier configurations in different carrier aggregation scenarios according to some aspects of some of various exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 8. A gNB and the UE may communicate using a serving cell. A serving cell may be associated with at least with one downlink CC (e.g., may be associated only with one downlink CC or may be associated with a downlink CC and an uplink CC). A serving cell may be a Primary Cell (PCell) or a Secondary cCell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance to keep the L1 synchronized. Serving cells having uplink to which the same timing advance applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single timing advance capability for CA may simultaneously receive and/or transmit on multiple CCs corresponding to multiple serving cells sharing the same timing advance (multiple serving cells grouped in one TAG). A UE with multiple timing advance capability for CA may simultaneously receive and/or transmit on multiple CCs corresponding to multiple serving cells with different timing advances (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity and for the MCG for communications with the master base station and one MAC entity for the SCG for communications with the secondary base station.

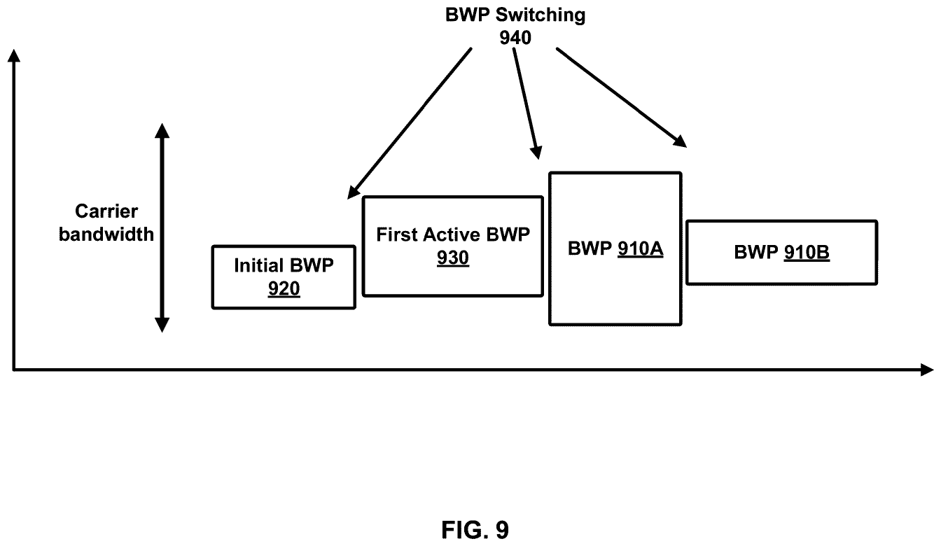

FIG. 9 shows example bandwidth part configuration and switching according to some aspects of some of various exemplary embodiments of the present disclosure. The UE may be configured with one or more Bandwidth Parts (BWPs) 910 on a given component carrier. In some examples, one of the one or more bandwidth parts may be active at a time. The active bandwidth part may define the UE's operating bandwidth within the cell's operating bandwidth. For initial access, and until the UE's configuration in a cell is received, initial bandwidth part 920 determined from system information may be used. With Bandwidth Adaptation (BA), for example through BWP switching 940, the receive and transmit bandwidth of a UE may not be as large as the bandwidth of the cell and may be adjusted. For example, the width may be ordered to change (e.g. to shrink during period of low activity to save power); the location may move in the frequency domain (e.g. to increase scheduling flexibility); and the subcarrier spacing may be ordered to change (e.g. to allow different services). The first active BWP 920 may be the active BWP upon RRC (re-)configuration for a PCell or activation of an SCell.

For a downlink BWP or uplink BWP in a set of downlink BWPs or uplink BWPs, respectively, the UE may be provided the following configuration parameters: a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with an OFDM numerology according to the configured subcarrier spacing and cyclic prefix for the BWP. For a serving cell, a UE may be provided by a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

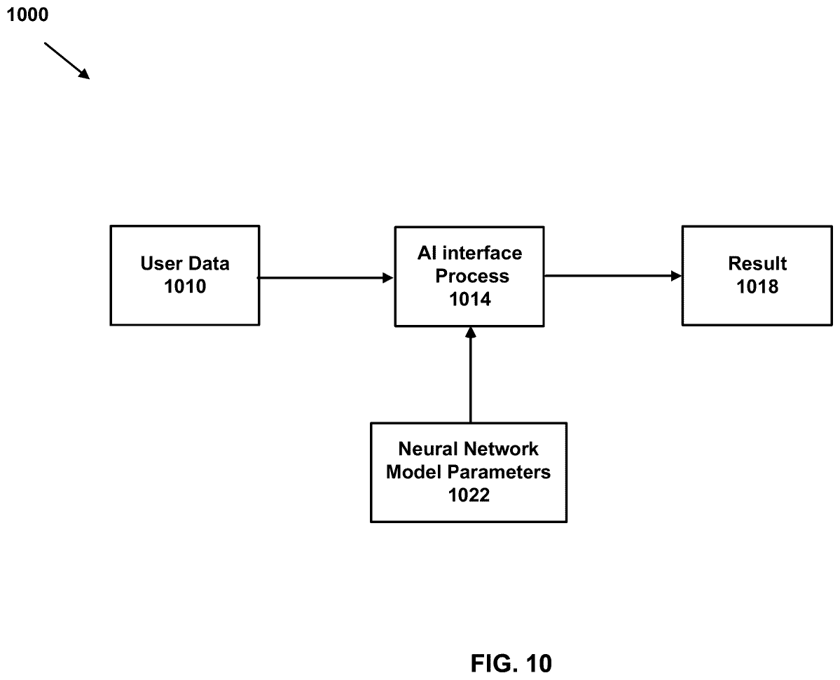

FIG. 10 shows an example of system block diagram of intelligent balanced model distribution according to some aspects of some of various exemplary embodiments of the present disclosure. The scheme 1000 may be employed in a network such as network 100 for intelligently configuring network parameters. The scheme 100 may include a user data block 1010, Artificial Intelligence (AI) block 1014, neural network model parameters block 1022, and result block 1018. In particular, FIG. 1 shows an AI process, which basically applies an AI model to the user data 1010 and produces the result 1018. The result 1018 may include network parameters required for communication between the UE and network (e.g., network 100).

Neural network model parameters block 1022 may include a neural network model based on existing AI model. The neural network is a series of algorithms that endeavors to recognize underlying relationships in a set of data through a process that mimics the way the human brain operates. In this sense, neural networks model parameters 1022 refers to systems of neurons, either organic or artificial in nature.

Neural networks, also known as artificial neural networks (ANNs) or simulated neural networks (SNNs), are a subset of machine learning and are at the heart of deep learning algorithms. Their name and structure are inspired by the human brain, mimicking the way that biological neurons signal to one another. Artificial neural networks (ANNs) are comprised of a node layers, containing an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network.

Neural networks rely on training data to learn and improve their accuracy over time. However, once these learning algorithms are fine-tuned for accuracy, they are powerful tools in computer science and artificial intelligence, allowing us to classify and cluster data at a high velocity. Tasks in speech recognition or image recognition can take minutes versus hours when compared to the manual identification by human experts.

The AI interface 1014, is an interface between the user data 1010, neural network model parameter 1022, and result 1018. The AI interface 1014 may provide protocols and data formats required for data transfer among the user data 1010, neural network model parameter 1022, and result 1018.

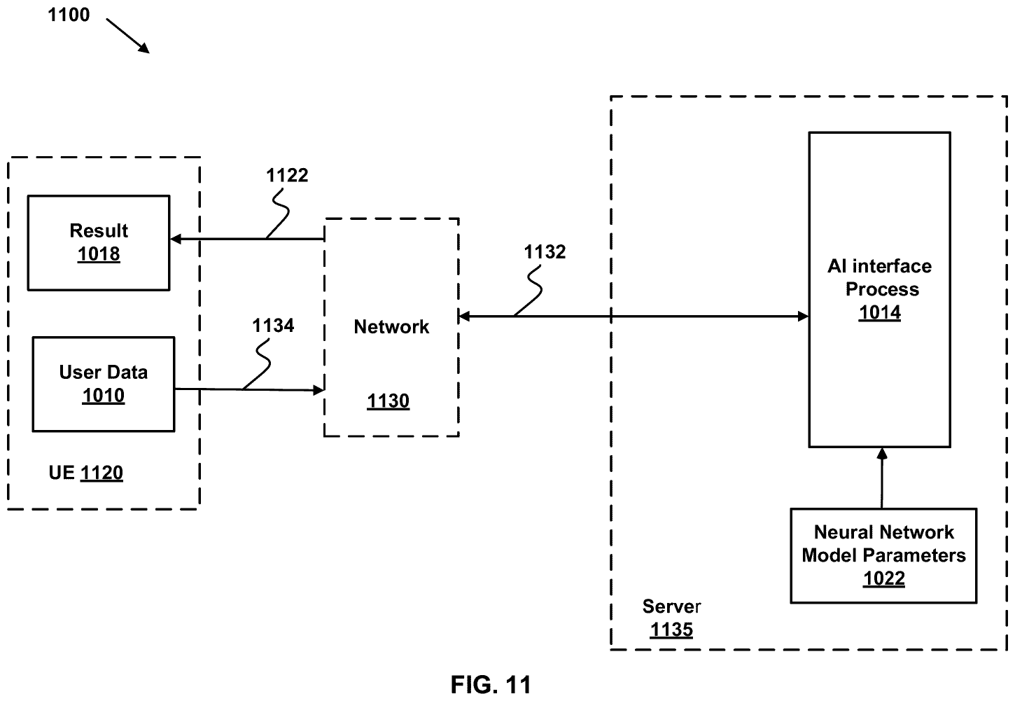

FIG. 11 shows an example of balanced model distribution when the user data is transferred from a UE to a server according to some aspects of some of various exemplary embodiments of the present disclosure. The scheme 1100 may be employed in a network such as network 100 for intelligently configuring network parameters. The scheme 1100 may include result 1018, user data 1010, UE 1120, network 1120, air interface 1014, neural network model parameters 1022, and server 1135. In particular, FIG. 11 shows an example of balanced load distribution in a wireless network when the user data 1010 is sent from the UE 1120 to the server 1135, and the result 1018 is then sent back to the user 1010. Network 1130 may include a wireless network such as network 100.

In FIG. 11, neural network model parameters 1022 is physically located in the server 1135. Data user 1010, is transferred via link 1134 to network 1130, and then to server 1135 via link 1130. AI interface process 1014 provided data protocols and format for the transfer of data between network 1130 and neural network model parameters 1022. Neural network parameter 1022 may include any an AI algorithm to intelligently process data user data 1120, and intelligently configure the parameters required for the communication between the UE 1120, and server 1135. The output data of neural network model parameters 1022, is transferred to UE 1120 via link 1132, 1122, and stored in result 1018. Result 1018 may include a database stored in UE 1120 local memory. The UE 1120 may read data from result 1018 for configuring network parameters or for the communication between UE 1120 and network 1130.

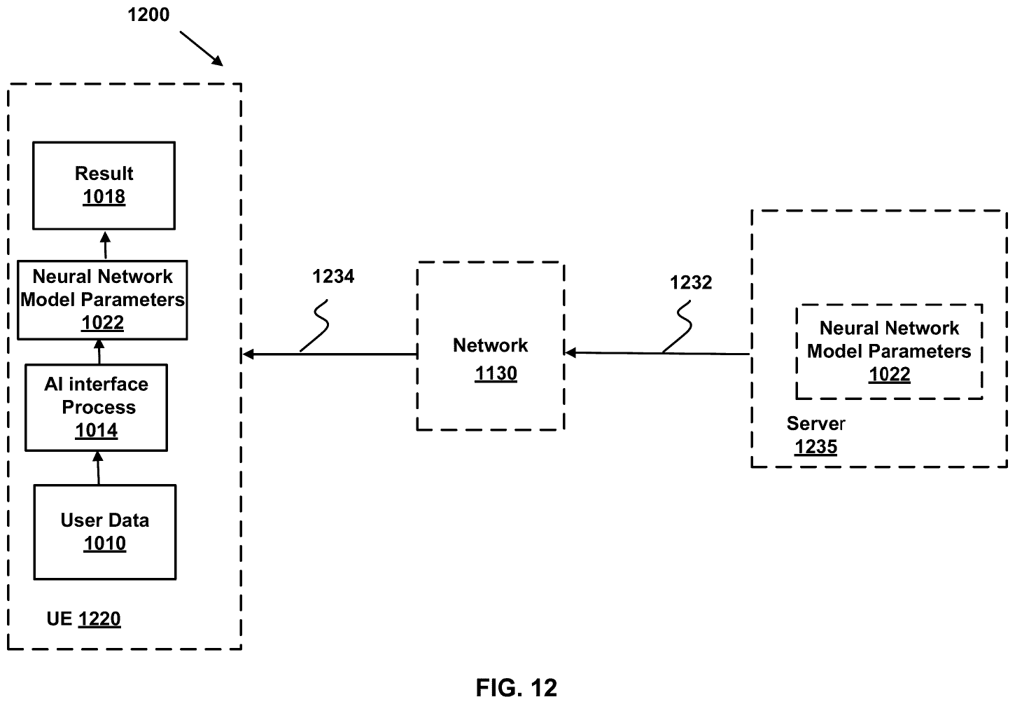

FIG. 12 shows an example of balanced model distribution when model is transferred from a server to a UE according to some aspects of some of various exemplary embodiments of the present disclosure. The scheme 1200 may be employed in a network such as network 100 for intelligently configuring network parameters. The scheme 1200 may include result 1018, user data 1010, UE 1120, network 1130, air interface 1014, neural network model parameters 1022, and server 1135. In particular, FIG. 12 shows the neural network model parameters 1022 sent to the UE 1220 and the process is performed at the UE. In this FIG., the cost to transfer neural network model parameters 1022 to UE 1220 is considered to be negligible.

In FIG. 12, the server 1235 transfers network model parameters 1022 to UE 1220. Since the UE data 1010 is local to UE 1220, neural network model parameters 1022 process data 1220 locally. Thus, in scheme 1200, there is no need to transfer user data 1220 to be processed at server 1235. The output data of neural network model parameters 1022, is stored in result 1018. Result 1018 may include a database stored in UE 1120 local memory. The UE 1120 may read data from result 1018 for configuring network parameters or for the communication between UE 1120 and network 1130.

The techniques discussed in FIG. 10-12 allow a very efficient use of neural network AI and machine learning (ML) models. The models may reside in appropriate network servers or may be downloaded to the UE to be used directly. A decision method needs to be implemented which optimizes the load on the network.

In some examples, server 1235 may decide whether transfer neural network model 1022 to UE or not. For example, server 1235 may perform the following steps:
i. Determine the cost CM to transfer the neural network model 1022 from the server to the UE
ii. Determine the cost Cy to transfer the UE data 1010 from the UE to the server
iii. Determine the cost CR to transfer the result 1018 from the server to the UE
iv. Determine if the UE has the capability to process the model. If the neural network model 1022 can be processed at the UE, then the server may decide whether the UE should process it.
v. Decide whether if the UE data 1010 is sent to the server 1235 or if the neural network model 1022 is sent to the UE 1220 based on a defined cost function.

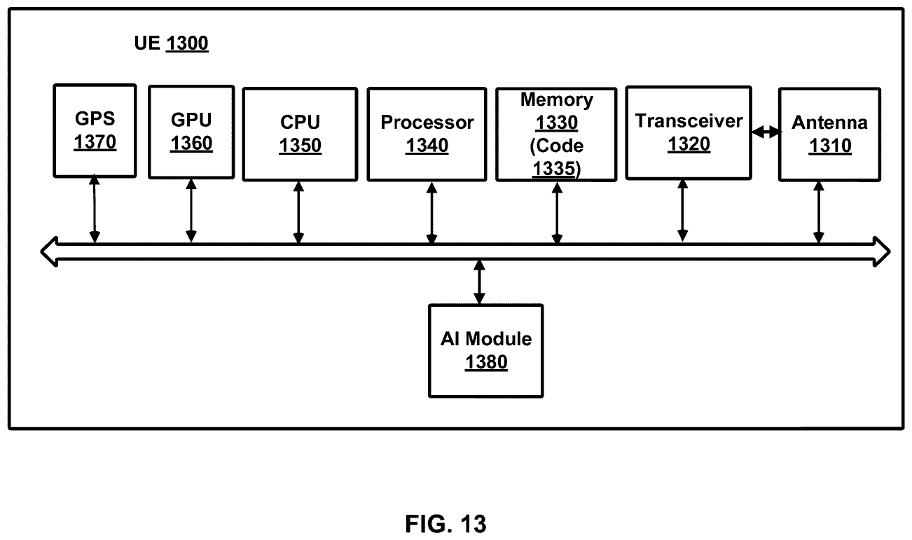

FIG. 13 shows example components of a UE for transmission and/or reception according to some according to some aspects of some of various exemplary embodiments of the present disclosure. All or a subset of blocks and functions in FIG. 13 may be in the UE 1300 and may be performed by the user equipment 1300. The Antenna 1310 may be used for transmission or reception of electromagnetic signals. The Antenna 1310 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 1310 may enable a massive MIMO configuration with tens or hundreds of antenna elements. The Antenna 1310 may enable other multi-antenna techniques such as beamforming. In some examples and depending on the UE 1300 capabilities, the UE 1300 may support a single antenna only.

The transceiver 1320 may communicate bi-directionally, via the Antenna 1310, wireless links as described herein. For example, the transceiver 1320 may represent a wireless transceiver at the UE 1300 and may communicate bi-directionally with the wireless transceiver at the base station or vice versa. The transceiver 1320 may include a modem to modulate the packets and provide the modulated packets to the Antennas 1310 for transmission, and to demodulate packets received from the Antennas 1310.

The memory 1330 may include RAM and ROM. The memory 1330 may store computer-readable, computer-executable code 1335 including instructions that, when executed, cause the processor to perform various functions described herein. In some examples, the memory 1330 may contain, among other things, a Basic Input/output System (BIOS) which may control basic hardware or software operation such as the interaction with peripheral components or devices.

The processor 1340 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1440 may be configured to operate a memory using a memory controller. In other examples, a memory controller may be integrated into the processor 1340. The processor 1340 may be configured to execute computer-readable instructions stored in a memory (e.g., the memory 1430) to cause the UE 1400 to perform various functions.

The Central Processing Unit (CPU) 1350 may perform basic arithmetic, logic, controlling, and Input/output (I/O) operations specified by the computer instructions in the Memory 1330. The user equipment 1300 and may include additional peripheral components such as a graphics processing unit (GPU) 1460 and a Global Positioning System (GPS) 1370. The GPU 1360 is a specialized circuitry for rapid manipulation and altering of the Memory 1330 for accelerating the processing performance of the user equipment 1300 and/or the base station 1305. The GPS 1370 may be used for enabling location-based services or other services for example based on geographical position of the user equipment 1300.

AI module 1380 may include an AI model, or algorithm to intelligently process UE data as described in FIGS. 10-12. For example, AI model 1380 may include a neural network to identify parameters needed for communication between UE 1300 and a network or server.

FIG. 14 shows example components of a server for transmission and/or reception according to some aspects of some of various exemplary embodiments of the present disclosure. All or a subset of blocks and functions in FIG. 14 may be in the server 1400 and may be performed by the server 1400. The Antenna 1410 may be used for transmission or reception of electromagnetic signals. The Antenna 1410 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 1410 may enable a massive MIMO configuration with tens or hundreds of antenna elements. The Antenna 1410 may enable other multi-antenna techniques such as beamforming. In some examples and depending on the BS gNB00 capabilities, the gNB 1500 may support a single antenna only.

The transceiver 1420 may communicate bi-directionally, via the Antenna 1410, wireless links as described herein. For example, the transceiver 1420 may represent a wireless transceiver at the server 1400 and may communicate bi-directionally with the wireless transceiver at the base station or vice versa. The transceiver 1420 may include a modem to modulate the packets and provide the modulated packets to the Antennas 1410 for transmission, and to demodulate packets received from the Antennas 1410.

The memory 1430 may include RAM and ROM. The memory 1430 may store computer-readable, computer-executable code 1435 including instructions that, when executed, cause the processor to perform various functions described herein. In some examples, the memory 1430 may contain, among other things, a Basic Input/output System (BIOS) which may control basic hardware or software operation such as the interaction with peripheral components or devices.

The processor 1440 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1440 may be configured to operate a memory using a memory controller. In other examples, a memory controller may be integrated into the processor 1440. The processor 1440 may be configured to execute computer-readable instructions stored in a memory (e.g., the memory 1530) to cause server 1400 to perform various functions.

The Central Processing Unit (CPU) 1450 may perform basic arithmetic, logic, controlling, and Input/output (I/O) operations specified by the computer instructions in the Memory 1430.

The AI module 1470, may include an AI model, or algorithm to intelligently process UE data as described in FIGS. 10-12. For example, AI model 1470 may include a neural network to identify parameters needed for communication between UE and a network or server 1400.

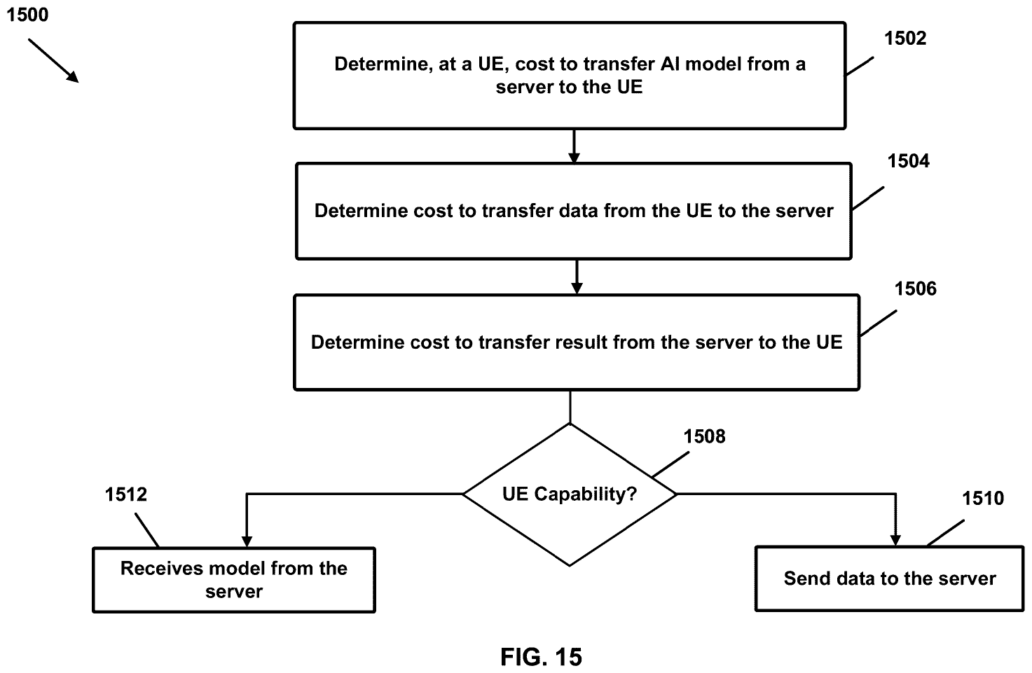

FIG. 15 is a flow diagram showing a flow diagram illustrating a method of balanced load distribution performed by a UE according to some aspects of some of various exemplary embodiments of the present disclosure. The steps of method 1500 can be executed by computing devices (e.g., a processor, processing circuit, and/or other components) of the UE. As illustrated, method 1500 may include additional steps before, after, and in between the enumerated steps.

At step 1502, a UE calculates the cost CM to transfer the neural network model parameter from a server to the UE.

At step 1504, the UE calculates the cost Cy to transfer the data from the UE to the server.

At step 1506, the UE calculates the cost CR to transfer the result from the server to the UE.

At step 1508, the UE determines if it has capability to process the neural network model parameters. If the neural network model can be processed on the UE, then it proceeds to step 1510, and receives the neural network model from the server, and process the data. Otherwise, it proceeds to step 1510, and send the data to server.

In some examples, inputs required for the decision making process are the parameters collected from the network, the server and the UE. As it is described below, a cost metric can be defined to decide if it is cheaper for the network to transfer the data from the UE to the server and apply the model at the server or if it is cheaper to transfer the model to the UE and make the calculation at the UE level.

In some other examples, the number of times the neural network parameter model is used may be used in defining the cost metric. If n is the number of cases where the same model is used before it may be deleted from the UE (e.g., the model is replaced by another model). This can be accomplished with a moving average window or with a decay factor. After a specified time period the following is applied to the use factor with t representing a time unit:

$${n}_{t + 1} = {n}_{t} ( 1 - α ) + u α , \leq α \leq 1$$

u represents the number of uses of the model in the current time period. Initially, use factor initially is n₀=0.0 because the model never has been used. In an example, α=0.5, then if the model is used 2 times between the first and the second time period, then n₁=1.0. Now, if the model is used again two times within the next time period it would lead to n₂=1.5, i.e. eventually approximating 2.0 if the use is always at 2 times per each time period. In another implementation, n may be multiplied with a factor other than 1.0, before it is used in the decision making process.

In another example, the download and upload bandwidth may differ, which means it may be more beneficial to download the model from the server to the UE despite it being larger. In these scenarios, the method performs the following steps:
i. Determine the available bandwidth to transfer data from the server to the UE i.e. the download bandwidth B_{D}
ii. Determine the available bandwidth to transfer data from the UE to the server i.e. the upload bandwidth B_{U}

With that new information the decision making process may be updated in the following way:
i. IF

$$\frac{{C}_{M}}{{B}_{D}} < n \frac{{C}_{U}}{{B}_{U}} + n \frac{{C}_{R}}{{B}_{D}}$$

then
ii. transfer model to UE
iii. ELSE
iv. transfer user data to server

The download bandwidth herein may affect both sending the model to the user as well as sending the results to the user. The upload bandwidth may only affect the user data which is transferred to the server with the model.

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of” or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

What is claimed is:

1. A method of load balancing in a wireless network, performed by a network server, comprising the steps of:
deriving an intelligent model to determine network parameters;
determining a model-download cost of transferring the intelligent model from the network server to a user equipment (UE);
determining a data-upload cost of transferring data to be processed by the intelligent model from the UE to the server;
determining a data-download cost of transferring output data processed by the intelligent model from the server to the UE;
determining to transfer the intelligent model from the server to the UE, or transfer the data from the UE to the server; and
processing the data by the intelligent model.

2. The method of claim 1, wherein the intelligent model includes an artificial intelligent model, which determines network parameters dynamically according to network traffic.

3. The method of claim 1, further comprising:
calculating a total cost of data transfer by adding the data-upload cost of transferring the data from the (user equipment) UE to the server, and the data-download cost of transferring the output data from the server to the UE;
comparing the total cost with the model-download cost of transferring the model from the server to the UE; and
transferring or not transferring the intelligent model to the UE based on the comparison result.

4. The method of claim 3, wherein the server transfers the intelligent model to the UE where the total cost is larger than the model-download cost of transferring the intelligent model to the user equipment (UE).

5. The method of claim 1, further comprises:
determining a number of times the intelligent model is used to process user equipment (UE) data;
calculating a sum of the data-upload cost of transferring the data from the UE to the server, and the data-download cost of transferring the output data from the server to the UE;
multiplying the sum by the number of times of the intelligent model is used to calculate a total cost of data transfer;
comparing the total cost of data transfer with the model-download cost of transferring the intelligent model from the server to the UE; and
transferring or not transferring the intelligent model to the UE based on the comparison result.

6. The method of claim 5, wherein the server transfers the intelligent model to the user equipment UE where the total cost is larger than the cost of transferring the intelligent model to the UE.

7. The method of claim 5, wherein the number of times the intelligent model is used is determined by a moving average process.

8. The method of claim 5, further comprises:
determining the number of times the intelligent model is used to process user equipment (UE) data;
calculating a first metric that is equivalent to a ratio of the upload-data cost of transferring the data from the UE to the server to available upload bandwidth;
calculating a second metric that is equivalent to a ratio of the download-data cost of transferring the output data from the server to available download bandwidth;
summing the first metric with the second metric;
multiplying the summation result by the number of times the intelligent model is used to calculate a total cost of data transfer;
comparing the total cost of data transfer with the download-model cost of transferring the model from the server to the UE; and
transferring or not transferring the intelligent model to the UE based on the comparison result.

9. The method of claim 8, wherein the number of times the intelligent model is used is determined by a moving average process.

10. The method of claim 8, wherein the download bandwidth is determined based on the downlink traffic.

11. The method of claim 8, wherein the upload bandwidth is determined based on the uplink traffic.

12. A server, comprising a processor and transceiver, wherein the processor is programmed to:
implement an intelligent model to determine network parameters;
determine a model-download cost of transferring the intelligent model from the network server to a user equipment (UE);
determine an upload-data cost of transferring data to be processed by the intelligent model from the UE to the server;
determine a download-data cost of transferring output data processed by the intelligent model from the server to the UE;
determine to transfer the intelligent model from the server to the UE, or transfer the data from the UE to the server; and
if the data are transferred to the server, process the data by the intelligent model;
wherein the transceiver is configured to:
receive the data uploaded from the UE; and
in a case where the data are uploaded to the server, transmit the output data processed by the intelligent model from the server to the UE.

13. The server of claim 12, wherein the intelligent model includes an artificial intelligent model which determines network parameters dynamically according to network traffic.

14. The server of claim 12, wherein the processor is further programmed to:
calculate a total cost of data transfer by adding a data-upload cost of transferring the data from the user equipment (UE) to the server, and a data-download cost of transferring output data from the server to the UE;
compare the total cost with the model-download cost of transferring the model from the server to the UE; and
transfer or not transfer the intelligent model to the UE based on the comparison result.

15. The server of claim 14, wherein the transceiver is further configured to transfer the intelligent model to the user equipment (UE) where the total cost is larger than the upload-data cost of transferring the intelligent model to the UE.

16. The server of claim 14, wherein the processor is further programmed to:
determine a number of times the intelligent model is used to process user equipment (UE) data;
calculate a sum of the upload-data cost of transferring the data from the UE to the server, and the download-data cost of transferring the output data from the server to the UE;
multiply the sum by the number of times of the intelligent model is used to calculate the total cost of data transfer;
compare the total cost with the model-download cost of transferring the model from the server to the UE; and
transfer or not transfer the intelligent model to the UE based on the comparison result.

18. The server of claim 12, wherein the processor is further programmed to transfer the intelligent model to the user equipment (UE) where the total cost is larger than the model-download cost of transferring the intelligent model to the UE.

19. The server of claim 14, wherein the processor is further programmed to:
determine a number of times the intelligent model is used to process user equipment (UE) data;
calculate a sum of the data-upload cost of transferring the data from the UE to the server, and the data-download cost of transferring the output data from the server to the UE;
multiply the sum by the number of times of the intelligent model is used to calculate the total cost of data transfer;
compare the total cost with the model-download cost of transferring the model from the server to the UE; and
transfer or not transfer the intelligent model to the UE based on the comparison result.

19. The server of claim 14, wherein the processor is further programmed to transfer the intelligent model to the user equipment (UE) where the total cost is larger than the model-download cost of transferring the intelligent model to the UE.

20. At least one non-transitory computer-readable storage medium having stored therein instructions which, when executed by one or more processors, cause the one or more processors to:
generate an intelligent model to determine network parameters;
determine a model-download cost of transferring the intelligent model from a network server to a user equipment (UE);
determine a data-upload cost of transferring data to be processed by the intelligent model from the UE to the network server;
determine data-download cost of transferring output data processed by the intelligent model from the network server to the UE;
determine to transfer the intelligent model from the server to the UE, or to transfer the data from the UE to the server;
cause the data to be processed by the intelligent model.
